(19) United States
(12) Patent Application Publication
(10) Pub. No.: US 2016/0080848 A1
(43) Pub. Date: Mar. 17, 2016

(54) Wireless Strand Speakers With Additional Lighting Feature

(71) Applicant: Corey Lieblein, Port Washington, NY (US)

(72) Inventor: Corey Lieblein, Port Washington, NY (US)

(21) Appl. No.: 14/952,677

(22) Filed: Nov. 25, 2015

Related U.S. Application Data
(60) Provisional application No. 62/190,278, filed on Jul. 9, 2015.
(60) Provisional application No. 62/214,532, filed on Sep. 4, 2015.

(51) Int. Cl. H04R 1/02; F21V 31/00; F21V 33/00; H04R 3/12; F21S 4/00

(52) U.S. Cl. CPC H04R 1/028; H04R 3/12; F21S 4/001; F21V 33/0056; F21V 31/00; H04R 2420/07

(57) ABSTRACT

A wireless speaker and a plurality of additional speakers connected wirelessly and/or hardwired to the wireless speaker. A male auxiliary connection connects one string of speakers to a “Host” string. On the opposing end of the string, a female auxiliary in connection for non-wired audio devices to connect to the speakers. A string of lights is also combined with a wireless speaker and a plurality of additional speakers connected wirelessly and/or hardwired to the wireless speaker. One end of the string of lights/speakers will have a female outlet that will enable users to plug into a second strand. On the opposing end of the light string, a male and female plug is provided to all the string to be connected to a standard power outlet and also provide a female plug providing access to the outlet.

### CROSS REFERENCE TO RELATED APPLICATIONS

This application claims priority from U.S. Patent Application Ser. No. 62/190,278, entitled “Strand Lighting with Speakers”, filed on Jul. 9, 2015. The benefit under 35 USC §119(e) of the United States provisional application is hereby claimed, and the aforementioned application is hereby incorporated herein by reference.

This application claims priority from U.S. Patent Application Ser. No. 62/214,532, entitled “Wireless Strand Speakers” filed on Sep. 4, 2015. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to speakers. More specifically, the present invention relates to wireless speakers that are portable or are used in a temporary or semi-permanent setting. Even more specifically, the present invention relates to decorative strand lighting that includes audio inputs and wireless speakers that are portable or are used in a temporary or semi-permanent setting.

### BACKGROUND OF THE INVENTION

Wireless speaker systems work well for installations where hard wiring the system into a structure is not an option. If a person is renting or are unable to run wiring in walls, the best type of wireless systems utilize a wireless network independent of the home Wi-Fi network. This prevents slowing down the computer network to have wireless audio.

Therefore what is needed is a wireless speaker system, that provides wireless connection to a first speaker that is wired to one or more additional speakers along a wire strand wherein the plurality of speakers on a “string” of the present invention allows consumers to integrate speakers into decorative lighting on Christmas Trees, Outdoor Umbrellas, Pergolas, or even place a plurality of speakers on or around a room giving the user a surround sound feel.

Ten years ago, string lights were what you put on your Christmas tree, now string lights are being used to give weddings a romantic glow, give a lamp a funky twist and turn a backyard from a space into a sanctuary. Every retailer that has anything to do with home decorating sells decorative string lights.

String lights are becoming increasingly more popular in home decor. In additional to lighting, which covers the visual experience, audio features are also increasing in popularity among home decorating to complement the visual experience or setting provided by the use of string lights. Audio features are currently limited to various indoor, and some limited outdoor wireless speakers.

Therefore, what is needed is a device that combines string lighting and wired and wireless speakers into one simple to use and control device that can be used indoor or outdoors and provide wireless connectivity to the wide variety of devices currently used to store and play music.

### SUMMARY OF THE INVENTION

The present invention is a plurality of speakers where the first speaker on the “strand” is a wireless BLUETOOTH Speaker and the other speakers on the strand are hard wire connected to the initial BLUETOOTH Speaker. In an alternative embodiment of the present invention all speakers are hard wired and the device will connect to the audio source via a standard 3.5 mm Aux Cord/Connection.

The present invention is a string of one or more speakers for use in a temporary or semi-permanent setting. The device can be used as home Décor, on an outdoor patio, a tree, an umbrella, or for audio mood setting in the home.

The present invention consists of a string of one or more wireless (BLUETOOTH) speakers and a plurality of additional speakers hardwired to the wireless speakers and a plurality of additional speakers hardwired to the wireless speaker. The first speaker on the string will be wireless, using BLUETOOTH or other wireless technology. The wireless speaker on the string will be paired to a device providing the audio and the rest of the speakers on the string will be hardwired/connected to the wireless speaker.

In another embodiment, the device has an auxiliary (AUX) connection so that the series of wired speakers may be plugged or otherwise physically connected to a device for playing music such as a smartphone or any portable music player such as an IPOD that is not equipped with wireless connection abilities.

In another embodiment, the device has an auxiliary (AUX) connection so a user can connect one string of speakers to a “Host” string. For the linked chain speakers, all speakers will be AUX including the first wireless speaker.

In a best mode, speakers will be spaced approximately 4-6 FEET apart. One end of the string will also provide a male auxiliary (AUX) in connection to connect to additional speakers. On the opposing end of the light string, a female auxiliary (AUX) in connection for non-wired audio devices to connect to the speakers.

In an alternative embodiment, a slide switch would be used to control the device. A slide switch would be able to turn the device on and off, and control speaker volume.

In yet another embodiment, a string of lights is used in combination with one or more speakers for decorative lighting. The device can be used as Christmas Tree Décor, on an outdoor patio, a tree, an umbrella, or for mood lighting in the home.

A string of lights is combined with a wireless (BLUETOOTH) speaker and a plurality of additional speakers hardwired to the wireless speaker. Bulbs can be incandescent or LED, and any color, both of which are well known in the art for string lighting. The first speaker on the string will be wireless, using BLUETOOTH or other wireless technology. The wireless speaker on the string will be paired to a device providing the audio and the rest of the speakers on the string will be hardwired/connected to the wireless speaker.

In another embodiment, a string of lights is combined with a series of wired speakers with wireless capability for receiving a wireless transmission of music to be emitted by the speakers. In another embodiment, a string of lights is combined with a series of wired speakers that does not have wireless capability and must be plugged or otherwise connected to a device for playing music such as a smartphone or any portable music player such as an IPOD.

In all embodiments, the device will have an auxiliary (AUX) connection so a user can connect one string of speakers to a “Host” string. For the linked chain speakers, all speakers will be AUX including the first wireless speaker.

In a best mode for the combination of speakers and lights, the speakers are spaced three inches apart along the string. One end of the string of lights/speakers will have a female outlet that will enable users to plug into a second strand of lights into the present invention using any other type of chain lights. This end will also provide a male auxiliary (AUX) in connection to connect to additional light sets that include speakers. On the opposing end of the light string, a male and female plug is provided to all the string to be connected to a standard power outlet and also provide a female plug so additional strings or other devices can have access to the outlet. This end will be provided with a female auxiliary (AUX) in connection for non-wired audio devices to connect to the speakers.

In an alternative embodiment, a slide switch would be used to control the device. slide switch would be able to turn the device on and off, set it to lights only, set it to speakers only, or set it to lights and speakers.

### BRIEF DESCRIPTION OF THE DRAWINGS

The accompanying drawings, which are incorporated herein a form a part of the specification, illustrate the present invention and, together with the description, further serve to explain the principles of the invention and to enable a person skilled in the pertinent art to make and use the invention.

FIG. 1 illustrates the prior art LED or traditional incandescent bulbs used in string lighting known in the art.

FIG. 2 illustrates the present invention, where a string of one or more speakers spaced along a wired strand and AUX (auxiliary) connections are provided as the ends of the strand for connection with non-wireless enabled devices.

FIG. 3 illustrates the present invention, where string lighting is shown in combination with one or more speakers spaced along the light strand and AUX (auxiliary) connections for non-wireless enabled devices at the opposing ends of the light string.

FIG. 4 illustrates the present invention, where an AUX (auxiliary) in connection for non-wireless enabled devices and one or more speakers spaced along the light strand and are located at one end of a light string with a male and female plug.

FIG. 5 illustrates the present invention, where an AUX (auxiliary) connection is provided for non-wireless enabled devices and one or more speakers spaced along the light strand and are located at one end of a light string with a female plug.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims. In the following description, numerous specific details are set forth to provide a thorough understanding of the invention. However, it is understood that the invention may be practiced without these specific details.

In other instances, well-known structures and techniques known to one of ordinary skill in the art have not been shown in detail in order not to obscure the invention. Referring to the figures, it is possible to see the various major elements constituting the apparatus of the present invention.

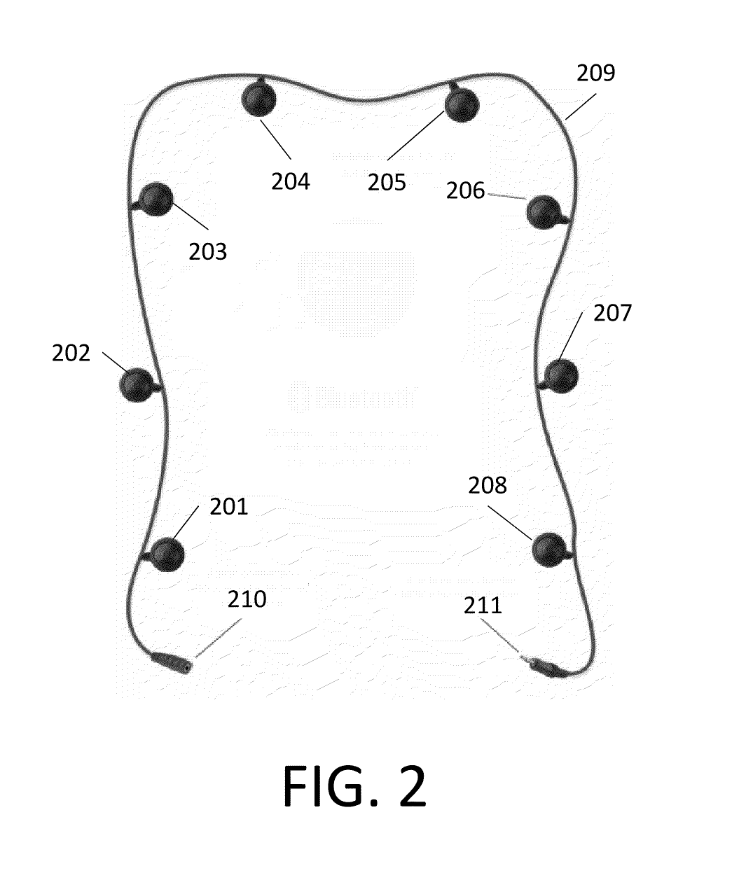

Now referring to FIG. 2, one embodiment of the present invention is illustrated. The present invention is strand of one or more speakers 201, 202, 203, 204, 205, 206, 207, and 208 for temporary and semi-permanent use. The device can be used as home Décor, on an outdoor patio, a tree, an umbrella, or for audio mood setting in the home.

The present invention consists of wireless (BLUETOOTH) speaker 208 and a plurality of additional speakers 201, 202, 203, 204, 205, 206, and 207 hardwired to the wireless speaker 208. The first speaker 208 on the string 209 will be wireless, using BLUETOOTH or other wireless technology. The wireless speaker 208 on the string 209 will be paired to a device providing the audio and the rest of the speakers 201, 202, 203, 204, 205, 206, and 207 on the string will be hardwired/connected to the wireless speaker 208.

In another embodiment, the device has an auxiliary (AUX) connection 2101 so that the series of wired speakers may be plugged or otherwise physically connected to a device for playing music such as a smartphone or any portable music player such as an IPOD that is not equipped with wireless connection abilities.

In another embodiment, the device has an auxiliary (AUX) connection 210 so a user can connect one string of speakers to a “Host” string. For the linked chain speakers, all speakers will be AUX 211 including the first wireless speaker 208.

In a best mode, speakers 201, 202, 203, 204, 205, 206, 207, and 208 are spaced 4-6 Feet Apart three inches apart along the string 209. One end of the string will also provide a female auxiliary (AUX) 210 out connection to connect to additional speakers. On the opposing end of the light string, a male auxiliary (AUX) in 211 connection for non-wired audio devices to connect to the speakers. The wireless speaker 208 on the string will be paired to a device providing the audio and the rest of the speakers 201, 202, 203, 204, 205, 206, and 207 on the string will be hardwired/connected to the wireless speaker 208.

In an alternative embodiment, a slide switch would be used to control the device. A slide switch would be able to turn the device on and off, and control speaker volume.

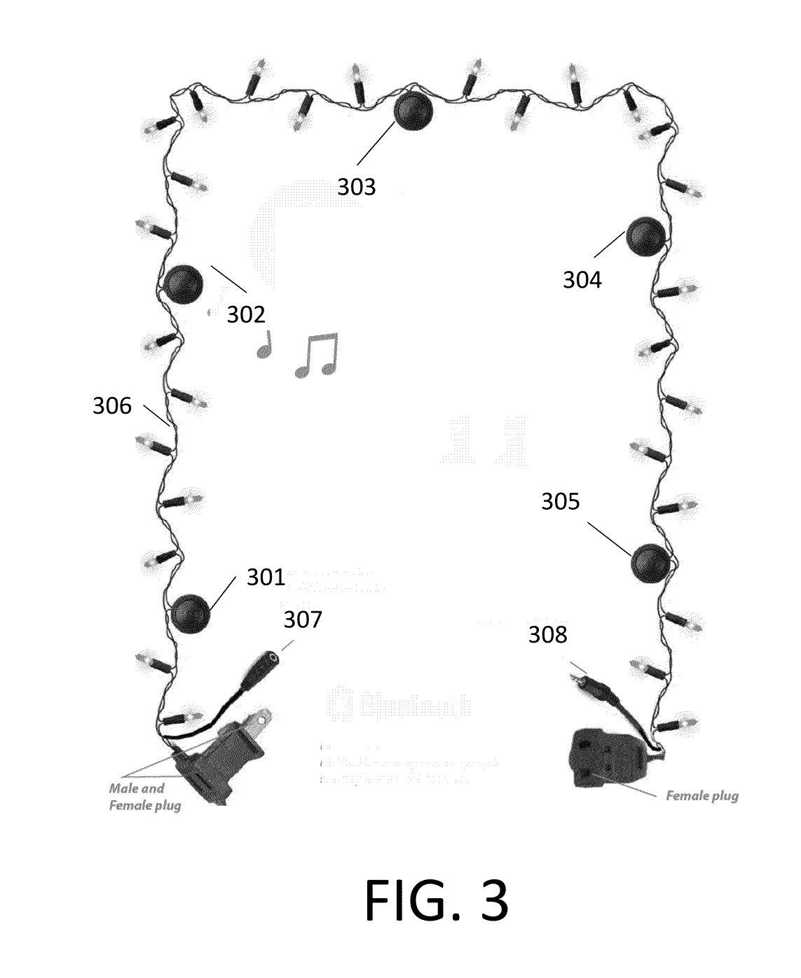

Now referring to FIG. 3, another embodiment of the present invention is illustrated. The present invention is a string light 306 in combination with one or more speakers 301, 302, 303, 304, and 305 for decorative lighting. The device can be used as Christmas Tree Décor, on an outdoor patio, a tree, an umbrella, or for mood lighting in the home.

In one embodiment, the string of lights 306 is combined with a wireless (BLUETOOTH) speaker 305 and a plurality of additional speakers 301, 302, 303, and 304 hardwired to the wireless speaker. In this embodiment, only one wireless speaker is used, reducing cost and system complexity.

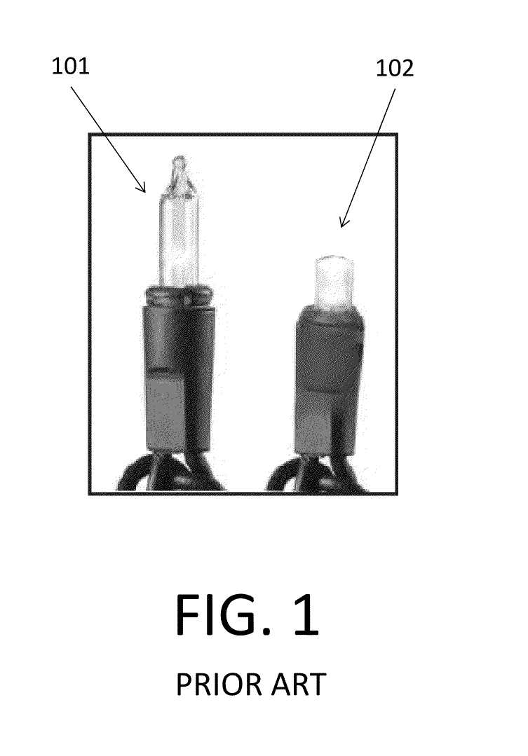

As shown in FIG. 1, Bulbs can be traditional incandescent 101 or LED 102, and of any color, both of which are well known in the art for string lighting. The first speaker on the string will be wireless, using BLUETOOTH or other wireless technology. The wireless speaker on the string will be paired to a device providing the audio and the first speaker on the string will be wirelessly connected to the rest of the speakers on the string.

In another embodiment, a string of lights is combined with a series of wired speakers with wireless capability for receiving a wireless transmission of music to be emitted by the speakers. Bulbs can be incandescent 101 or LED 102, and of any color. The first speaker on the string will be wireless, using BLUETOOTH or other wireless technology. The wireless speaker on the string will be paired to a device providing the audio and the rest of the speakers on the string will be hardwired/connected to the wireless speaker.

In another embodiment shown in FIG. 3, a string of lights 306 is combined with a series of wired speakers 301, 302, 303, 304, and 305 that does not have wireless capability and must be plugged or otherwise connected to a device for playing music such as a smartphone or any portable music player such as an IPOD. The device will have an auxiliary (AUX) connection 307 so a user can connect one string of speakers to a “Host” string. For the linked chain speakers, all speakers will be AUX in including the first and last speakers on the chain 301 and 308, whether they are wireless or hard wired to each other.

In a non-wireless embodiment, at a lower price point speaker size should not exceed the size of a “Golf Ball”. The smallest thinnest, lightest, inexpensive speaker possible should be used. Speakers should have between ½ Watt to 5 Watts each. Speakers will be placed every 4 or 5 feet apart along the light string. It would be understood by a person of ordinary skill in the art that any size of speakers could be selected for use in the invention.

Bulbs can be incandescent or LED, and of any color, both of which are well known in the art for string lighting. Lights should be spaced three inches apart along the string. It would be understood by a person of ordinary skill in the art that the space between each of the speakers can be increased or decreased as desired for any number of reasons.

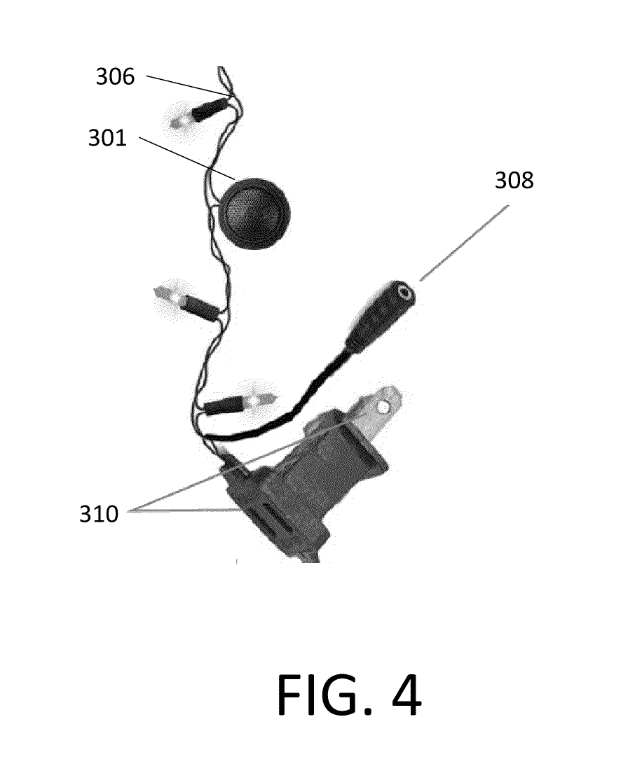

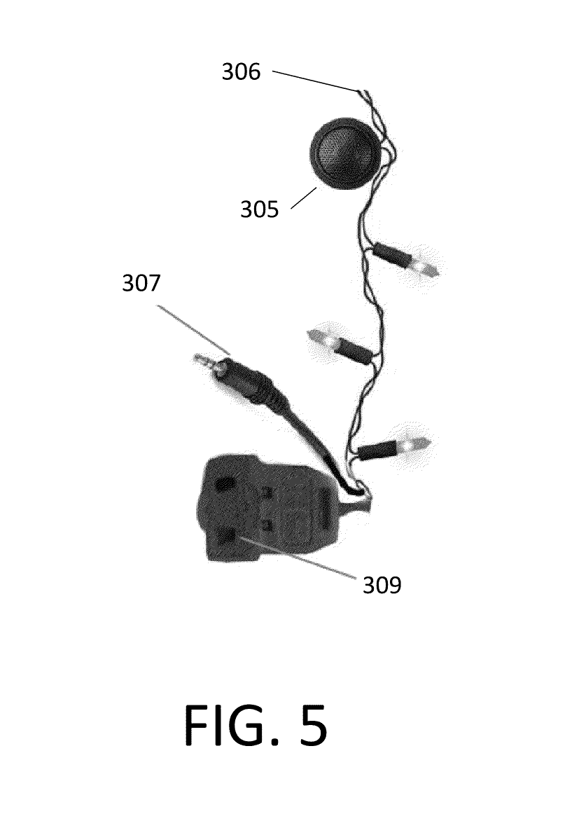

Additionally, one end of the string of lights/speakers as shown in FIG. 5 will also provide a female outlet 309 that will enable users to plug into a second strand of lights into the present invention using any other type of chain lights. This end will also provide a male auxiliary (AUX) in connection 307 to connect to additional light sets that include speakers. On the opposing end of the light string, as shown in FIG. 4, a male and female plug 310 is provided to all the string to be connected to a standard power outlet and also provide a female plug so additional strings or other devices can have access to the outlet. This end will be provided with a female auxiliary (AUX) in connection 308 for non-wired audio devices to connect to the speakers.

The device will be constructed from weather proof indoor/outdoor cord for both the light wiring and speaker wiring. Outdoor versions or outdoor/indoor versions would be constructed from weather proof cord materials readily available and known in the prior art. Indoor only version would be constructed from indoor cord materials readily available and known in the prior art which are cheaper and lighter than weather proof materials, resulting in a lower cost indoor product/embodiment. The device will use black or green cord color only, and be sold in 20, 30, and 40 foot sections. It would be readily understood to a person of ordinary skill in the art that the type of cord, or cord selection for indoor and/or outdoor use would be obvious from existing material selections. Additionally, one of ordinary skill in the art would also find the selection of any cord color and length to be an obvious design choice.

In an alternative embodiment, a wired or wireless remote control option for controlling the speakers and lights.

In yet another embodiment, a rechargeable battery option would add a rechargeable battery pack to the overall unit in case there is no physical outlet near where the product will be used, which provides the product with mobility to tailgate parties, camping, and other such remote events that commonly have no power available, but would benefit from decorative the ability to play and hear music over a given area of the event. The mechanism for the rechargeable battery is not fully developed or shown, but it will be a similar mechanism to how a camera battery is inserted into a camera.

Lighting options will include three different types of light modes: on, flash/blink, and pulse to music. It would be readily understood to a person of ordinary skill in the art that any other lighting options could be used.

In yet another embodiment, a rechargeable battery option would add a rechargeable battery pack to the overall unit in case there is no physical outlet near where the product will be used, which provides the product with mobility to tailgate parties, camping, and other such remote events that commonly have no power available, but would benefit from decorative lighting and the ability to play and hear music over a given area of the event. The mechanism for the rechargeable battery is not fully developed or shown, but it will be a similar mechanism to how a camera battery is inserted into a camera.

In still another embodiment, solar power would be used along or in combination with battery or plug-in power to power the speakers and lights at the same time.

In an alternative embodiment, a slide switch would be used to control the device. The slide switch would be able to turn the device on and off, set it to lights only, set it to speakers only, or set it to lights and speakers.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A strand speaker device comprising:
a plurality of speakers strung together in combination,
a wireless speaker and a plurality of additional speakers hardwired to each other. the first speaker on the string is wireless, using wireless technology to obtain input;
the first speaker on the string is wired to a plurality of additional speakers hardwired to each other;
the wireless speaker on the string is paired to a device providing the audio; and
the rest of the speakers on the string are hardwired/connected to each other.

2. The strand speaker device of claim 1, further comprising
an auxiliary (AUX) connection so a user can connect one string of speakers to a another string of speakers.

3. The strand speaker device of claim 2, wherein for the linked chain speakers, all speakers will be AUX including the first wireless speaker.

4. The strand speaker device of claim 1, wherein
the speakers should have between ½ Watt to 5 Watts each; and
the speakers are placed every 4 to 5 feet apart along the light string.

5. The strand speaker device of claim 1, wherein
on one end of the string of speakers will have a male auxiliary (AUX) in connection to connect to additional speaker sets.

6. The strand speaker device of claim 5, wherein
on the opposing end of the speaker string, a female auxiliary (AUX) in connection for non-wired audio devices to connect to the speakers is provided.

7. The strand speaker device of claim 1, wherein
the device will be constructed from weather proof indoor/outdoor cord for the speaker wiring;
black or green cord color, and
sold in 20, 30, and 40 foot sections.

8. The strand speaker device of claim 1, further comprising
a wired or wireless remote control option for controlling the speakers; and
a rechargeable battery pack.

9. The strand speaker device of claim 1, further comprising
a slide switch used to control the device; and
the slide switch would be able to turn the device on and off.

10. A strand lighting device comprising:
a plurality of lights strung together in combination with a plurality of speakers for decorative lighting;
wherein the string of lights is combined with a wireless speaker and a plurality of additional speakers hardwired to each other; and
the wireless speaker is wired to a plurality of additional speakers hardwired to each other.

11. The strand lighting device of claim 10, wherein bulbs can be incandescent or LED of any color.

12. The strand lighting device of claim 10, wherein
the first speaker on the string is wireless, using wireless technology to obtain input;
the wireless speaker on the string will be paired to a device providing the audio;
the first speaker on the string is wired to a plurality of additional speakers hardwired to each other;
the rest of the speakers on the string are hardwired/connected to each other; and
the rest of the speakers on the string are hardwired/connected to the wireless speaker.

13. The strand lighting device of claim 10, further comprising
an auxiliary (AUX) connection so a user can connect one string of speakers to a “Host” Chain; and
wherein for the linked chain speakers, all speakers will be AUX including the first wireless speaker.

14. The strand lighting device of claim 10, wherein
the speakers should have between ½ Watt to 5 Watts each; and
placed every 3 to 4 to 5 feet apart along the light string;
lights are spaced three inches apart along the string.

15. The strand lighting device of claim 10, wherein
one end of the string of lights/speakers will have a female outlet that will enable users to plug into a second strand of lights into the present invention using any other type of chain lights; and
this end will also provide a male auxiliary (AUX) in connection to connect to additional light sets that include speakers.

16. The strand lighting device of claim 15, wherein
on the opposing end of the light string, a male and female plug is provided to all the string to be connected to a standard power outlet and also provide a female plug so additional strings or other devices can have access to the outlet; and
this end will be provided with a female auxiliary (AUX) in connection for non-wired audio devices to connect to the speakers.

17. The strand lighting device of claim 10, wherein
the device will be constructed from weather proof indoor/outdoor cord for both the light wiring and speaker wiring;
black or green cord color, and
sold in 20, 30, and 40 foot sections.

18. The strand lighting device of claim 10, further comprising
a rechargeable battery pack;
a wired or wireless remote control option for controlling the speakers and lights;
the remote providing one or more lighting mode options; and
lighting options include three different types of light modes:
on;
flash/blink; and
pulse to music.

19. The strand lighting device of claim 1, further comprising
a slide switch used to control the device;
the slide switch would be able to turn the device
on and off;
set it to lights only;
set it to speakers only; or
set it to lights and speakers.
